(19) United States
(12) Patent Application Publication
(10) Pub. No.: US 2003/0078094 A1
(43) Pub. Date: Apr. 24, 2003

(54) Method and systems for cashless gaming

(75) Inventors: Jean-Marie Gatto, London (GB); Thierry Brunet De Courssou, Palto Alto, CA (US)

Correspondence Address: YOUNG LAW FIRM, A PROFESSIONAL CORPORATION, 4370 ALPINE ROAD SUITE 106, PORTOLA VALLEY, CA, 94028

(73) Assignee: CYBERSCAN TECHNOLOGY, INC., Palo Alto, CA (US)

(21) Appl. No.: 10/052,893

(22) Filed: Oct. 19, 2001

(51) Int. Cl. G06F 17/00

(52) U.S. Cl. 463/25

(57) ABSTRACT

The present cashless gaming methods, systems and devices make use of printed coded tickets that include visible machine and human readable symbols. A coded ticket may be delivered by an automatic teller device in exchange of remitted cash or other form of electronic money. A coded ticket may also be printed by a gaming machine when the player wishes to offload his or her credit balance and/or winnings. The player may redeem his or her credit balance via an automated teller device, or alternatively may upload the credit on another gaming machine by presenting the coded ticket to the game machine's code scanner and manually providing the human readable verification code printed on the coded ticket. The present gaming machines are preferably configured within a secure managed network controlled by a server located at the gaming premise's back office or at a location remote therefrom. The server securely tracks and records all credit balances, game transactions and authorizes cash redemptions. The remote server may control several geographically separated gaming premises.

### BACKGROUND OF THE INVENTION

1. Field of the Invention

The invention generally pertains to the field of gaming machines, and more particularly to methods and systems for cashless gaming.

2. Description of the Related Art

Traditional gaming machines make use of coins and banknotes for entering play and for winning prizes. New generation gaming machines make use of magnetic identification cards, smart chip identification cards or electronic purse smart cards as cashless means when playing and winning prizes. The cards are issued by a human teller in exchange for remitted cash, or dispensed by an ATM (automated teller machine) that accepts coins, notes and/or electronic credit/debit fund transfers. Redemption of winnings is via a human teller or an ATM upon presentation of the card and optional authorization from the server that controls the system of gaming machines.

Magnetic cards and smart cards require sophisticated devices to encode the cards. In addition, bulk automatic card dispensers may jam and requiring costly servicing. Apart from expensive contact-less smart cards, the reading of magnetic and smart cards is carried out via a contact process that may fail when dirt or corrosion accumulate on the card feeding or reading mechanisms.

The procurement, printing, encoding and logistics costs associated with the widespread deployment of such magnetic and smart cards available at the point of sale require significant investment. Moreover, disgruntled players may tamper with or damage the cards and render them useless when depleted cards are returned for recycling, further increasing overhead costs.

It is also believed that players may be reluctant to trust sophisticated high technology cashless payment means that include invisible information, and that may fail when claiming winnings or prizes.

### SUMMARY OF THE INVENTION

The present invention addresses the above-cited disadvantages of conventional gaming methods and systems and provides improved methods and systems for cashless gaming. According to an embodiment of the present invention, a cashless gaming system includes a server; a first device coupled to the server, the first device being configured to enable a game to be played, to debit or credit a first credit balance depending upon an outcome of the game, to store the first credit balance on the server and to provide a first coded ticket that includes at least the first credit balance and a first authentication information provided by the server; a second device coupled to the server, the second device including a second scanner to read and decode at least a portion of the first authentication information upon presentation of the first coded ticket, the second device being further configured to retrieve the first credit balance associated with the decoded first authentication information and to dispense a first amount of money equal to the retrieved first credit balance to a holder of the first coded ticket.

The first device may include a printer configured to print and to dispense the first coded ticket. The first authentication information may be visible on the first coded ticket. The first authentication information may include a first machine-readable code and a first human readable verification code. The first machine-readable code may include a barcode, for example. The first device may include a first scanner configured to read and decode at least a portion of the first authentication information upon presentation of the first coded ticket, the first device being configured to retrieve from the server the first credit balance associated with the decoded first authentication information. The second device may be configured to accept a second amount of money and to provide a second coded ticket, the second coded ticket including second authentication information and an indication of a second credit balance, the second credit balance being at least equal to the second amount of money accepted.

The present invention may also be viewed as a cashless gaming device, comprising an electronic game; a scanner for reading and decoding a first coded ticket, the ticket including a first authentication information and a credit balance, the credit balance being updated depending upon an outcome of the game, and a printer for printing a second coded ticket, the second coded ticket including a second authentication information and the updated credit balance.

The first authentication information may include a first machine-readable code and a first human readable verification code and the second authentication information may include a second machine-readable code and a second human readable verification code. The first and second machine-readable codes may be obtained from a server across a network. The first and second human readable verification codes may also be obtained from a server across a network. The first authentication information may include a barcode and the second authentication information may also include a barcode. The device may further include manual entry means for enabling a manual entry of the human readable verification code.

According to another embodiment thereof, the present invention is an automated teller device, comprising a scanner for reading and decoding a first coded ticket presented thereto, the first coded ticket including a first authentication information and a first credit balance; money dispensing means for dispensing a first amount of money corresponding to the first credit balance; money accepting means for accepting a second amount of money; a printer for printing a second coded ticket, the second coded ticket including a second authentication information and a second credit balance corresponding to the second amount of money.

The money accepting means may be configured to accept cash and/or electronic money stored or accessed through a card (credit card, backcard, debit card, smart card and the like). The first authentication information may include a first machine-readable code and a first human readable verification code and the second authentication information may include a second machine-readable code and a second human readable verification code. The first and second machine-readable codes may be obtained from a server across a network. The first and second human readable verification codes may also be obtained from a server across a network. The first authentication information may include a barcode and the second authentication information may also include a barcode. The device may further include manual entry means for enabling a manual entry of the human readable verification code. The money dispensing means may be configured to dispense cash and/or electronic money (through a credit card, bankcard, debit card, smart card or the like, for example).

According to a still further embodiment, the present invention is a method for a player to play a game without using cash, comprising the steps of presenting a first coded ticket to a scanner of a gaming machine, the first coded ticket including a first machine-readable code, a first human readable verification code and a first credit balance; manually entering the human readable verification code; playing the game, the first credit balance being updated depending upon an outcome of the game, the game ending when the first or updated credit balance is zero or when the player requests to be paid an amount of money corresponding to the updated credit balance, and printing a second coded ticket, the second coded ticket including authentication information and the updated credit balance.

A step may be carried out of presenting the second coded ticket to a teller and receiving the amount of money corresponding to the updated credit balance upon the teller verifying the authentication information. The teller may be a human teller or may be an automated teller device. The authentication information may include a second machine-readable code and a second human readable verification code. The gaming machine may obtain the first machine-readable code and the first human readable verification code from a server over a network. The first and second machine-readable code may include a barcode, for example. The gaming machine may obtain the second machine-readable code and the second human readable verification code from a server over a network. The first and second machine-readable codes are preferably visible.

The present invention, according to another embodiment thereof, may be viewed as a method of dispensing money, comprising the steps of reading and decoding a machine-readable code printed on a coded ticket; prompting a holder of the coded ticket to manually enter a human readable verification code printed on the coded ticket; transmitting the machine-readable code and the human readable verification code to a server over a network; receiving from the server an authorization to dispense an amount of money to the holder of the coded ticket, and dispensing the amount of money.

The server may maintain a unique account corresponding to the machine-readable code and the human readable verification code, the account storing information indicative of the amount of money to dispense to the holder of the coded ticket. The dispensing step may include dispensing cash and/or crediting an account identified by a card (such as a credit card, bankcard, debit card, smart card or the like). A credit balance may be printed on the coded ticket.

### BRIEF DESCRIPTION OF THE DRAWINGS

For a further understanding of the objects and advantages of the present invention, reference should be made to the following detailed description, taken in conjunction with the accompanying figures, in which:

FIG. 1 is an exemplary diagram of a coded ticket in accordance with an embodiment of the present invention.

FIG. 2 is a diagram of a machine-readable barcode in accordance with an embodiment of the present invention.

FIG. 3 is a diagram of a machine-readable barcode in PDG format, in accordance with an embodiment of the present invention.

FIG. 4 is a diagram of a machine-readable barcode in Xerox DataGlyphs® format, in accordance with another embodiment of the present invention.

FIG. 5 is a diagram of an Automatic Teller Machine (ATM) with which aspects of the present inventions may be practiced.

FIG. 6 is a diagram of a cashless gaming machine in accordance with an embodiment of the present invention.

FIG. 7 is a diagram of a cashless gaming system in a local area network, in accordance with an embodiment of the present invention.

FIG. 8 is a diagram of a cashless gaming system in a wide area network in accordance with an embodiment of the present invention.

FIG. 9 is a flowchart depicting an ATM cash deposit and coded ticket printing and dispensing method in accordance with an embodiment of the present invention.

FIG. 10 is a flowchart depicting gaming machine cashless operation, in accordance with an embodiment of the present invention.

FIG. 11 is a flowchart depicting a method for redeeming the credit balance shown on a coded ticket from an ATM, according to an embodiment of the present invention.

### DETAILED DESCRIPTION OF THE INVENTION

The present cashless gaming method makes use of printed coded tickets that include at least visible machine and human readable symbols. A coded ticket may be delivered under the control of a human teller or by an automatic teller machine or device in exchange of remitted cash or other form of electronic money. A coded ticket may also be printed by a gaming machine when the player (or the holder of the coded ticket) wishes to offload his or her credit balance and/or winnings.

The player or coded ticket holder may redeem his or her credit balance or winnings via a human teller or via an automated teller machine or device, or alternatively may upload the credit on another gaming machine by presenting the coded ticket to the gaming machine's code scanner and manually keying-in, entering or otherwise providing the human readable verification code printed on the coded ticket.

The present gaming machines are preferably configured within a secure managed network controlled by a server located at the gaming premise's back office or at a location remote therefrom. The server securely tracks and records all credit balances, game transactions and authorizes cash redemptions. The remote server may control several geographically separated gaming premises.

The cashless method of the present invention considerably reduces costs associated with cash substitutes such as credit cards and smart cards, as the printing of the coded ticket is inexpensive and reliable. Moreover, machine-readable scanners (such as, for example, barcode scanners) do not require contact or a motorized operation and consequently provide long operational service lifetimes without frequent cleaning or servicing.

It is to be noted that bar-coded tickets delivered at points of sale are widely used in lotteries and are unquestionably trusted by players even when claiming prizes amounting to several millions of dollars. Consequently, it is anticipated that the present invention is unlikely to encounter significant resistance from the gaming public and is likely to become widely deployed and accepted.

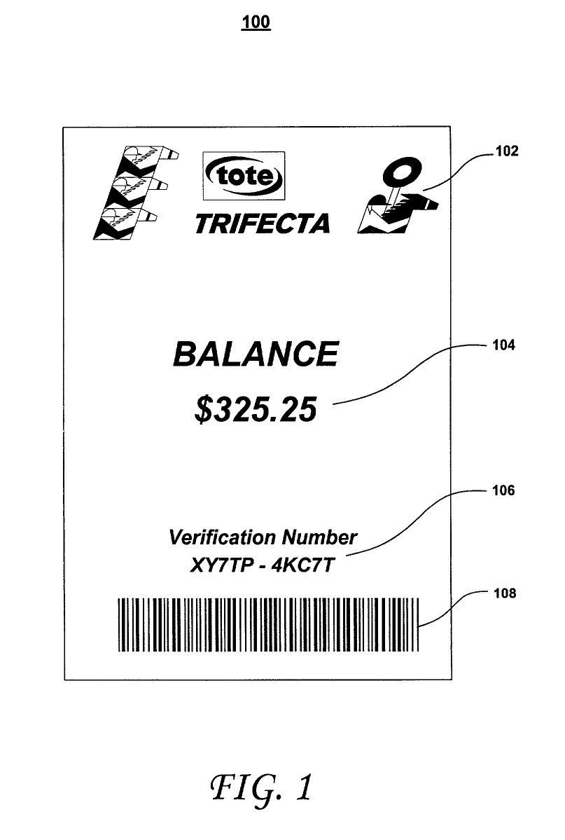

FIG. 1 is a diagram of an exemplary cashless coded ticket 100 in accordance with an embodiment of the present invention. As shown therein, the coded ticket 100 may include one or more logos, identifying information and/or security features, as shown at 102. The player's credit balance 104 may also be clearly printed (in human readable form) on the coded ticket 100. The present cashless method, systems and devices utilize printed coded tickets that include visible machine-readable codes and human readable verification codes. As shown in FIG. 1 and according to an embodiment of the present invention, the coded ticket 100 may include a human readable verification code 106. The human readable verification code 106 may include a string of numbers, letters and/or symbols, for example. The coded ticket 100 may also include a machine-readable code imprinted thereon, as shown at 108. The coded tickets 100 may be printed on paper or any other hand transportable printable media such as cardboard or plastic, for example. Printing technologies for printing the coded tickets 100 may include be thermal, impact, inkjet and laser, for example.

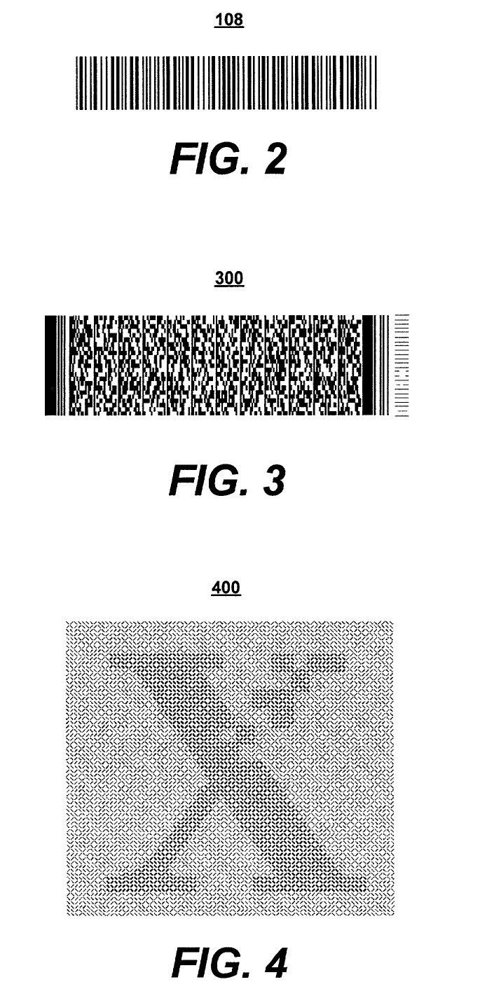

According to one embodiment, the coded ticket 100 of the present invention, the machine-readable code includes a barcode 108, as shown in FIG. 2. Alternatively, the present coded ticket 100 may include visible machine-readable code(s) other than barcodes. For example, the machine-readable code may be 2 of 5 ID-barcode, a PDF417 2D-Barcode 300 as shown in FIG. 3 or a Xerox DataGlyphs® 2D-Barcode 400 as shown in FIG. 4. Alternatively or in conjunction therewith, the present coded ticket 100 may include any other machine-readable code or codes that are visible to humans and/or machines.

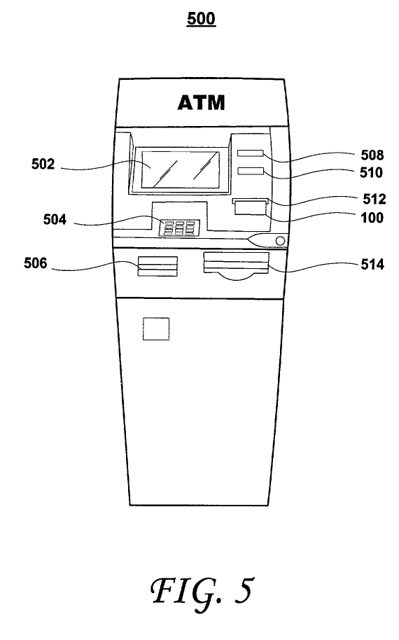

FIG. 5 is a diagram of an Automatic Teller Machine (ATM) or device 500 with which aspects of the present inventions may be practiced. As shown therein, the ATM 500 includes a display 502 (may be or include a touch screen display), a numeric and/or alphanumeric keypad 504 for entering information, a deposit slot 506 for depositing cash, a card slot 508 configured to read at least magnetic and smart cards (e.g., cards with an embedded microprocessor and/or memory), a machine readable code scanner 510, a printer 512 for printing a coded ticket 100 and a cash dispenser 514. Internally, the ATM 500 comprises secure storage for coins and banknotes. The exemplary ATM 500 may alternatively include features other than those shown in FIG. 5. For example, the ATM 500 may include multiple displays 502. As will become apparent in the description below, one or more human tellers may provide the same services as the ATM 500 within the context of the present invention. The present ATM 500 may, but need not, include the functionalities customarily associated with ATMs owned or operated by banking or financial institutions. According to the present invention, the ATM 500 may be any device that is configured to read or scan the player's coded ticket 100, print a coded ticket 100 and dispense money (cash or some form of electronic money) to the player in the amount shown on his or her coded ticket 100.

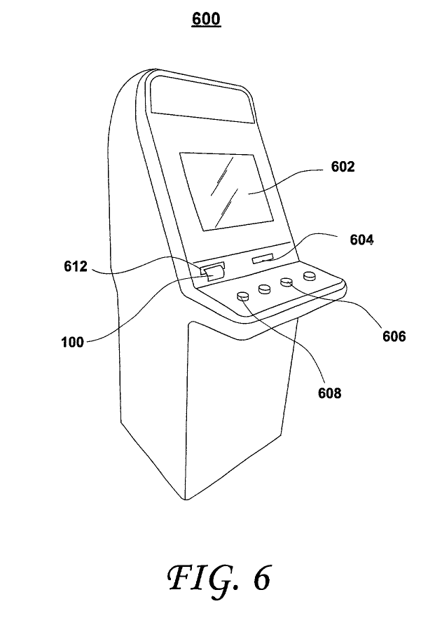

FIG. 6 is a diagram of a cashless gaming machine 600 in accordance with an embodiment of the present invention. The gaming machine 600 shown on FIG. 6 is equipped with a modern video display 602 (may include a touch screen), an integrated ticket printer 612 for printing coded tickets 100, a machine-readable code scanner 604 and one or more buttons 606, 608 and/or a joystick, roller ball or any means of enabling a player to interact with the gaming machine 600 and play a game. The machine-readable code scanner 604 may carry out the decoding of the machine-readable code (such as, for example, the machine-readable codes shown in FIGS. 2, 3 and 4) printed on the coded ticket 100 using most any image capture devices such as a CCD scanner, a laser scanner, a flatbed scanner, a feed scanners and/or a photographic or video 2D image camera, for example. However, most any electronic gaming machine may be suitably fitted or retrofitted with a display, a machine-readable code scanner, a ticket printer, a processing unit and communication capability.

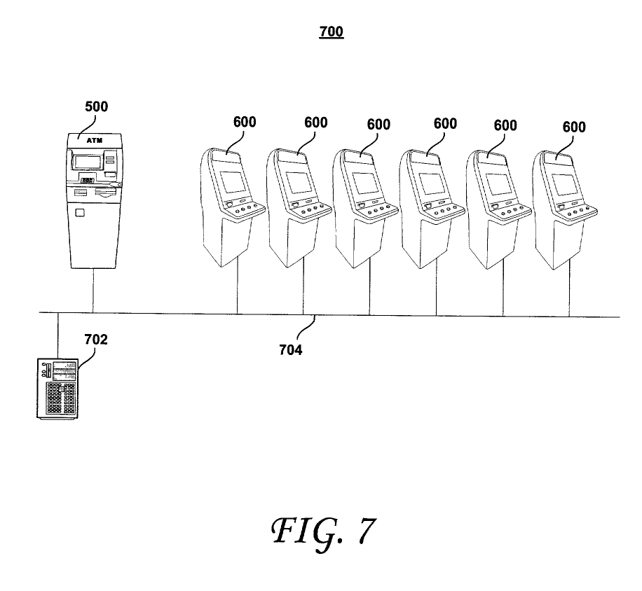

FIG. 7 is a diagram of a cashless gaming system 700 in a local area network (LAN) 704 in accordance with an embodiment of the present invention. The gaming machines 600 and ATMs 500, according to the present invention are preferably configured as a part of a secure managed network controlled by a server 702 located at the gaming premise's back office or some other remote location.

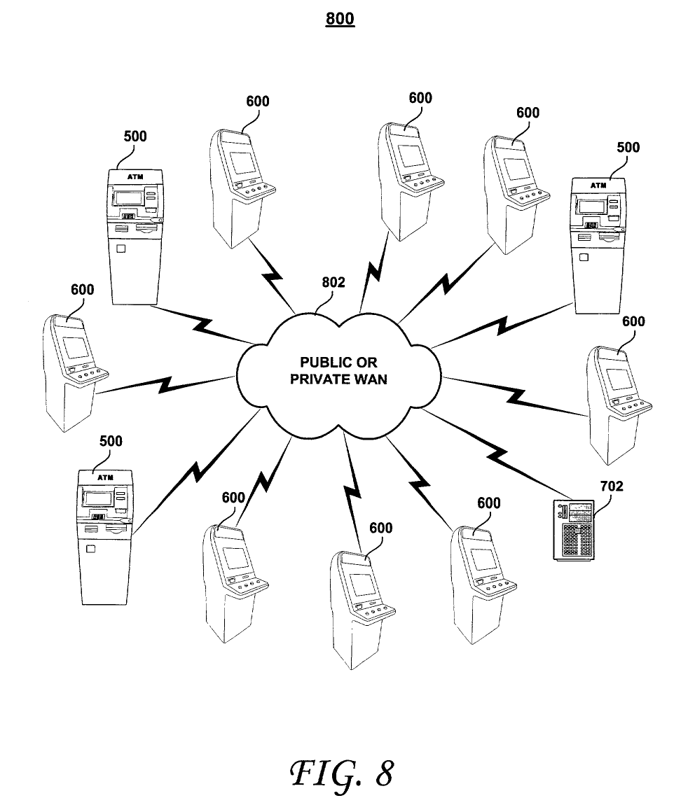

FIG. 8 is a diagram of a cashless gaming system 800 in a wide area network (WAN) 802 in accordance with an embodiment of the present invention. As shown therein, the present cashless gaming system 800 may include a plurality of ATMs 500, a plurality of gaming machines 600 and multiple servers 702 (one shown), preferably configured for fault tolerance and/or disaster recovery. Alternatively one or more human tellers may carry out the functions discharged by the ATMs 500. Moreover, the WAN 802 may be coupled to one or more networks 700, as shown in FIG. 7. The ATMs 500 and gaming machines 600 may be co-located and/or the remote server(s) 702 may control several geographically separated gaming premises comprising ATMs 500 and gaming machines 600, isolated gaming machines 600 and/or isolated ATMs 500. The WAN 802 may include a network such as the Internet, for example.

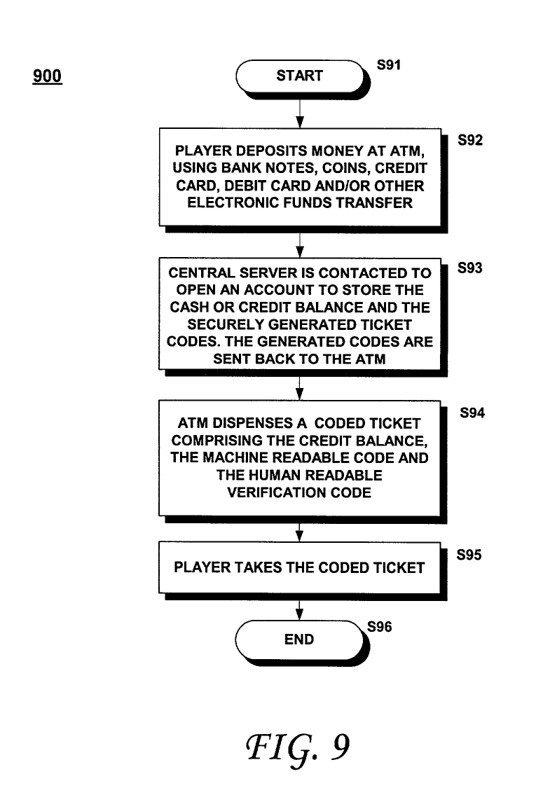

FIG. 9 is a flowchart depicting an ATM cash or electronic funds deposit and coded ticket 100 printing and dispensing method 900 in accordance with an embodiment of the present invention. As shown therein, the method begins at step S91, whereupon a player (not shown) deposits cash (banknotes, coins, tokens, etc.) at the ATM 500. The player may also use his or her credit card, debit card, bankcard or smart card for example to deposit cash or otherwise obtain credit, as shown at S92. It is to be understood that the player may, within the context of the present invention, utilize most any form of electronic money accepted by the ATM 500 to obtain credit in exchange for actual money deposited or otherwise transferred to the ATM 500 or in exchange for a promise to pay. As outlined in step S93, the server 702 may then be contacted by the ATM 500 to open an account for the player and to store the player's cash and/or credit balance. The server 702 may then securely and (e.g., randomly) generate both the human readable verification code 106 and the machine-readable code 108 that will be visibly printed on the coded ticket 100 of the present invention. The generated human readable verification code 106 and the machine-readable code 108 are then stored within the account opened by the server 702 for the player. Both the human readable verification code 106 and the machine-readable code 108 are then sent back to the ATM 500. At S94, the ATM 500 prints a coded ticket 100 that bears at least both the human readable verification code 106 and the machine-readable code 108 and dispenses the coded ticket to the player. The player then takes the coded ticket 100 and is ready to operate the gaming machines 600 in accordance with the present invention. If the player decides not to play the gaming machines 600, he or she may present the printed coded ticket back to the ATM 500 and obtain his or her money back, as described in detail below.

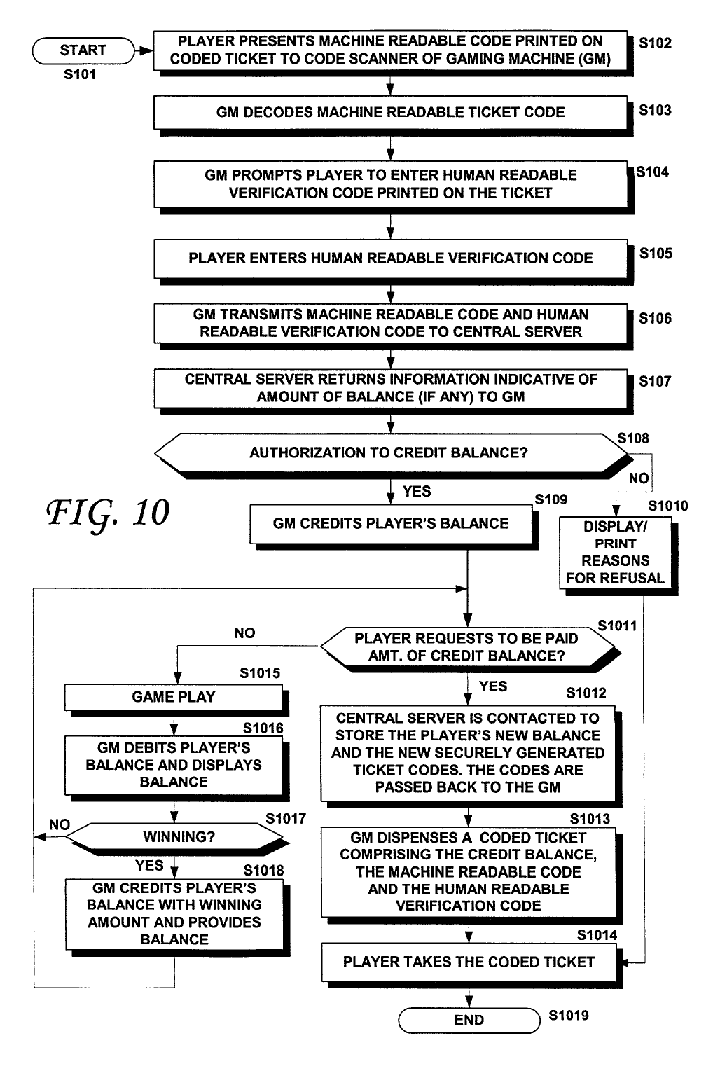

FIG. 10 is a flowchart depicting a method of cashless gaming, in accordance with an embodiment of the present invention. As shown therein, the method begins at S101, after which the player presents his or her coded ticket 100 to the gaming machine 600. More particularly, the player presents the machine-readable code 108 (such as, for example, a barcode as shown in FIG. 1) to the scanner 604 of a gaming machine 600, as shown at S102. At S103, the gaming machine 600 scans or otherwise reads and decodes the machine-readable code 108 of the coded ticket 100. The gaming machine 600, according to the present invention, then prompts the player to manually enter or otherwise provide the gaming machine 600 with the human readable verification code 106 printed on the coded ticket presented to the gaming machine 600, as called for by step S104. At S105, the player, in response to the prompt by the gaming machine 600, manually enters (by whatever means, e.g., keypad, pointing device, voice, etc.) the human readable verification number of the coded ticket 100 presented to the gaming machine 600. The gaming machine 600 may then, as shown at S106, transmit at least the machine-readable code 108 scanned from the coded ticket 100 and the human readable code 106 entered by the player to a server 702. The gaming machine 600 may also transmit additional information to the server 702 such as, for example, additional authentication information obtained upon scanning the machine-readable code 108, for example. The server 702, after having suitably verified the authenticity of the coded ticket 100 (by at least confirming that the manually entered human readable verification code corresponds or is associated with the decoded machine-readable code from the player's ticket 100), may then transmit information indicative of the player's current credit balance to the gaming machine 600. For example, the player may have previously obtained a coded ticket 100 in accordance with the method outlined relative to FIG. 9, for example. In step S108, the server 702 determines whether to credit the player's account with the amount indicated on the coded ticket 100 presented to the gaming machine 600. If the server 702 determines not to credit the player's account for whatever reason (such as failure of the authentication process, for example), the player is so notified at S1010, where the gaming machine 600 may display, print or otherwise communicate to the player the reasons for the failure to credit the player's account. The player may then take his or her printed ticket or notification at step S1014. If the server 702 determines that the player's account should be credited with the amount shown on the player's coded ticket presented to the gaming machine 600, the player's account is so credited, as shown at S109.

If, in step 1011, the player wishes to play the game(s) available on the gaming machine 600 (such as, for example, a virtual racing game as disclosed in commonly assigned and co-pending U.S. application Ser. No. 09/838,563 entitled “Methods And Systems For Electronic Virtual Races”, although any other electronic game may be played on the gaming machine 600), the player is allowed to play the game (and place a wager thereon), as shown at S1015. The gaming machine 600 may then suitably debit the player's credit balance and may display the player's new balance, as shown at S1016. If then player wins the game (Yes branch of S1017), the gaming machine 600 may credit the player's balance with the amount that the player has won and again displays or otherwise provides the player with his or her new credit balance. The player may continue to play until his or her credit balance is zero or until the player wishes, at step S1010, to be paid the amount of his or her credit balance. If the player, in step S1011 decides to quit the game or decides not to play and wishes to be paid the amount of his or her credit balance (YES branch of S1011), the server 702 is contacted by the gaming machine 600 and the gaming machine transmits the player's credit balance to the server 702. In response thereto, the server 702 credits the player's account with the amount of the player's current credit and generates a new machine-readable code and a new human readable verification code. Other information may also be generated by the server 702 at that time (such as, for example, a precise date and time stamp, for example). At least the machine-readable code and the human readable verification code are then transmitted to the gaming machine 600, as shown at S1012. At S1013, the gaming machine 600 prints out a coded ticket 100 bearing at least the player's new balance, the machine-readable code 108 and the human readable verification code 106. The player may then take the coded ticket 100 and redeem the printed credit balance for cash or some form of electronic money at the ATM 500, as described below.

FIG. 11 is a flowchart depicting a method for redeeming the credit balance shown on a coded ticket 100 from an ATM 500, according to an embodiment of the present invention. As shown therein, the method starts at S111, whereupon the player at S112 presents the coded ticket 100 to the ATM 500. More particularly, the player may present the machine-readable code 108 printed on the coded ticket 100 to the scanner 510 of the ATM 500. The ATM 500 then reads and decodes the machine-readable code 108 of the player's coded ticket 100 at S113 and prompts the player to enter the human readable verification code 106 at S114. The player then manually enters (by whatever means) the human readable verification code 106 printed on his or her coded ticket 100, as shown at S105. The ATM 500 may then transmit the entered human readable verification code 106 to the server 702 over the LAN 704 and/or the WAN 802 and/or over any computer network including, for example, the Internet. The transmitted information is then received by the server 702. The server 702 may then authenticate the player's coded ticket 100. For example, the server 702 may verify that the machine readable code 108 received from the ATM 500 for this coded ticket 100 is associated with the human readable verification code 106 read from the player's ticket 100 and that both the machine readable code 108 and the human readable verification code 106 received from the ATM 500 match the previously stored machine readable code 108 and the human readable verification code 106 for this account. Other authentication steps may be carried out to verify the authenticity of the coded ticket 100. At S117, the server 702 sends the ATM 500 information indicative of the amount of the player's credit balance (which may be zero or larger than zero). At S118 it is determined whether the ATM 500 has been given authorization from the server 702 to pay any available credit to the player. For example, if the credit balance 104 is greater than zero and if the coded ticket 100 is properly authenticated, the server 702 may authorize the ATM 500 to dispense an amount of money (in whatever form) that is less than or equal to the amount of the credit balance 104 indicated on the player's coded ticket 100. If, for whatever reason (zero credit balance, tampered coded ticket, etc.), the server 702 does not give the ATM 500 authorization to dispense money to the player (NO branch of S118), the reason(s) for the refusal may be communicated to the player at S119 by printing and/or displaying the reasons for the refusal, for example.

If, however, the server 702 does give the ATM 500 authorization to dispense money to the player (or to any holder or bearer of the coded ticket 100), the ATM 500 may dispense an amount that is less than or equal to the amount of the player's credit balance, as shown at S1110. The ATM may dispense cash, tokens, credit a bankcard or credit card account and/or transfer any form of electronic money or other value to the player, as appropriate and depending upon the capabilities of the ATM 500. The method ends at S1112.

According to one embodiment of the present invention, the act of entering the human readable verification code into the ATM 500 constitutes the player's implicit instructions to be paid the entire credit balance 104 shown on the coded ticket 100, and to invalidate the coded ticket. For example, the coded ticket 100 may be branded or otherwise marked such that subsequent scannings of the coded ticket 100 will result in a “No Value—Credit Already Used” message (for example) being printed onto the coded ticket 100 and/or otherwise displayed or communicated to the player. For example, the methods and devices disclosed in co-pending and commonly assigned U.S. application Ser. No. 09/782,839 entitled “Compact Document Scanner With Branding” filed on Feb. 14, 2001 may be advantageously employed to invalidate a coded ticket whose credit balance has been redeemed. However, other means of invalidating, destroying or otherwise rendering a used coded ticket unusable may be readily implemented within the context of the present invention. The server(s) 702 preferably keeps track of credit balances for many players across various ATMs 500 and gaming machines 600. Preferably, known secure mechanisms are implemented in software to ensure that the players' credit balances are properly managed. Advantageously, the present method, devices and systems are believed to offer reliable, low cost and proven solutions for cashless gaming.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below

What is claimed is:

1. A cashless gaming system, comprising:
a server;
a first device coupled to the server, the first device being configured to enable a game to be played, to debit or credit a first credit balance depending upon an outcome of the game, to store the first credit balance on the server and to provide a first coded ticket that includes at least the first credit balance and a first authentication information provided by the server;
a second device coupled to the server, the second device including a second scanner to read and decode at least a portion of the first authentication information upon presentation of the first coded ticket, the second device being further configured to retrieve the first credit balance associated with the decoded first authentication information and to dispense a first amount of money equal to the retrieved first credit balance to a holder of the first coded ticket.

2. The system of claim 1, wherein the first device includes a printer configured to print and to dispense the first coded ticket.

3. The system of claim 1, wherein the first authentication information is visible on the first coded ticket.

4. The system of claim 1, wherein the first authentication information includes a first machine-readable code and a first human readable verification code.

5. The system of claim 4, wherein the first machine-readable code includes a barcode.

6. The system of claim 1, wherein the first device includes a first scanner that is configured to read and decode at least a portion of the first authentication information upon

19. The automated teller device of claim 14, wherein the first authentication information includes a barcode and the second authentication information includes a barcode.

20. The automated teller device of claim 14, further including manual entry means for enabling a manual entry of the human readable verification code.

21. The automated teller device of claim 14, wherein the money dispensing means is configured to dispense at least one of cash and electronic money.

22. A method for a player to play a game without using cash, comprising the steps of:
presenting a first coded ticket to a scanner of a gaming machine, the first coded ticket including a first machine-readable code, a first human readable verification code and a first credit balance;
manually entering the human readable verification code;
playing the game, the first credit balance being updated depending upon an outcome of the game, the game ending when the first or updated credit balance is zero or when the player requests to be paid an amount of money corresponding to the updated credit balance, and
printing a second coded ticket, the second coded ticket including authentication information and the updated credit balance.

23. The method of claim 22, further including the step of presenting the second coded ticket to a teller and receiving the amount of money corresponding to the updated credit balance upon the teller verifying the authentication information.

24. The method of claim 23, wherein the teller is one of a human teller and an automated teller device.

25. The method of claim 22, wherein the authentication information includes a second machine-readable code and a second human readable verification code.

26. The method of claim 22, wherein the gaming machine obtains the first machine-readable code and the first human readable verification code from a server over a network.

27. The method of claim 25, wherein the first and second machine-readable code includes a barcode.

28. The method of claim 25, wherein the gaming machine obtains the second machine-readable code and the second human readable verification code from a server over a network.

29. The method of claim 25, wherein the first and second machine-readable codes are visible.

30. A method of dispensing money, comprising the steps of:
reading and decoding a machine-readable code printed on a coded ticket;
prompting a holder of the coded ticket to manually enter a human readable verification code printed on the coded ticket;
transmitting the machine-readable code and the human readable verification code to a server over a network;
receiving from the server an authorization to dispense an amount of money to the holder of the coded ticket, and dispensing the amount of money.

31. The method of claim 30, wherein the server maintains a unique account corresponding to the machine-readable code and the human readable verification code, the account storing information indicative of the amount of money to dispense to the holder of the coded ticket.

32. The method of claim 30, wherein the dispensing step includes one of dispensing cash and crediting an account identified by a card.

33. The method of claim 30, wherein a credit balance is printed on the coded ticket.
